(19) United States
(12) Patent Application Publication
(10) Pub. No.: US 2005/0008536 A1
(43) Pub. Date: Jan. 13, 2005

(54) Method and apparatus for surface sampling

(75) Inventors: James David Wilson, Denton, TX (US); Robert D. Estrada, El Paso, TX (US)

Correspondence Address: BAKER BOTTS L.L.P., 2001 ROSS AVENUE, SUITE 600, DALLAS, TX, 75201-2980, US

(73) Assignees: Cumorah, Inc. d/b/a The Provident Group; ERTECH Management Company, LLC

(21) Appl. No.: 10/703,764

(22) Filed: Nov. 6, 2003

Related U.S. Application Data
(60) Provisional application No. 60/424,722, filed on Nov. 8, 2002.

(51) Int. Cl. G01N 31/22

(52) U.S. Cl. 422/56

(57) ABSTRACT

According to one embodiment of the invention, a test strip for obtaining a test sample includes an adhesive substrate that includes a first surface and a second surface. The second surface includes a first adhesive layer adhering at least a portion of the adhesive substrate to a backing. A first handling surface is positioned proximate to a first end of the substrate. A second handling surface is positioned proximate to a second end of the substrate. The first and second handling surfaces define a contact area for collecting a test sample.

### RELATED APPLICATIONS

This application is related to and claims the benefit of pending U.S. Provisional Application Ser. No. 60/424722 entitled Mycological Sampling Strip, filed on Nov. 8, 2002.

### TECHNICAL FIELD OF THE INVENTION

This invention relates generally to the field of microbiological sampling, and more specifically, to an improved method and apparatus for reducing contamination associated with obtaining test samples.

### BACKGROUND OF THE INVENTION

Houses and other buildings may be periodically tested for microbiological contamination. Test samples are obtained by a field technician who generally captures the test sample on a standard piece of clear adhesive tape. For example, the field technician may pull a piece of clear adhesive tape from a roll. The piece of tape may be pressed against a wall or other surface to capture a test sample in the adhesive on the tape. The piece of tape may then be adhered to a microscope slide which may be viewed under microscopic magnification by a lab technician who may identify the test sample and any other contaminating marks or deposits on the tape. Because the clear adhesive tape is pulled directly from the roll and handled by the field technician, many contaminating marks and deposits other than the test sample must be identified to determine whether microbiological contamination is present at the test site.

### SUMMARY OF THE INVENTION

According to one embodiment of the invention, a test strip for obtaining a test sample includes an adhesive substrate that includes a first surface and a second surface. The second surface includes a first adhesive layer adhering at least a portion of the adhesive substrate to a backing. A first handling surface is positioned proximate to a first end of the substrate. A second handling surface is positioned proximate to a second end of the substrate. The first and second handling surfaces define a contact area for collecting a test sample.

Some embodiments of the invention provide numerous technical advantages. Other embodiments may realize some, none, or all of these advantages. For example, an advantage may be that test samples may be captured in a defined contact area on the test strip. For example, the configuration of the test strip may define a contact area that contains the test sample taken from the test site. Another advantage may be that the contact area provides defined borders at which lab technicians may focus while inspecting the test strip. Accordingly, the lab technicians who must identify the test sample need not identify stray contamination present on the test strip outside the contact area. Still another advantage may be that contamination resulting from the field technician's fingers is not seen by the lab technicians. As such, problems associated with stray contamination may be reduced, and the quality and functionality of the test strip may be improved.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 illustrates an example sheet of test strips in accordance with an embodiment of the invention;

FIGS. 2A-2C illustrate various example test strips in accordance with particular embodiments of the invention;

FIGS. 3A-3C illustrate an example method of using a test strip in accordance with an embodiment of the invention; and

FIG. 4 illustrates an example tool for obtaining test samples in accordance with an embodiment of the invention.

### DETAILED DESCRIPTION OF EXAMPLE EMBODIMENTS OF THE INVENTION

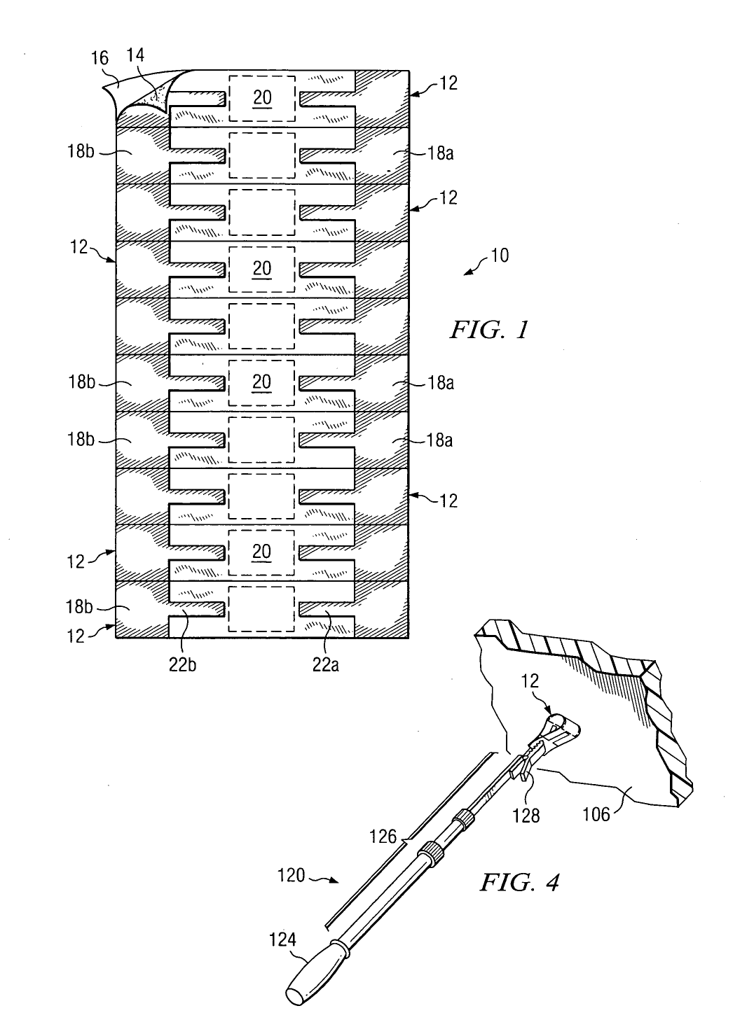

Example embodiments of the present invention and their advantages are best understood by referring now to FIGS. 1 through 4 of the drawings, in which like reference numerals refer to like parts.

FIG. 1 illustrates an example sheet 10 of test strips 12 in accordance with an embodiment of the invention. Test strips 12 include an adhesive substrate 14 adhered to a backing 16. Test strips 12 also include one or more handling surfaces 18 that define a contact area 20 associated with each test strip 12. A test strip 12 may be removed from backing 16, and a portion of test strip 12 may be pressed against a test site to obtain a test sample on test strip 12. The test sample may include a mold, fungus, or other bacteria that may be captured on contact area 20 for identification. Handling surfaces 18 of test strip 12 may be configured to reduce stray contamination captured on test strip 12. Alternatively or additionally, handling surfaces 18 may be formed such that contamination resulting from fingers or other sources goes undetected during the identification process.

Test strip 12 includes a substrate 14 comprising a flexible and substantially transparent material. The flexible nature of substrate 14 allows test strip 12 to be manipulated by a user so that a test sample may be obtained on contact area 20. The substantially transparent nature of substrate 14 allows light to pass through substrate 14 such that a test sample captured on test strip 12 may be viewed under microscopic magnification. When viewed under microscopic magnification, substrate 14 may appear substantially transparent to the lab technician who is studying the test strip 12. Accordingly, substrate 14 may include treated polystyrene or other thermoplastic similar to materials used in scotch tape. In particular embodiments, substrate 14 may be comprised of FASSON 2 MIL SUPER CLEAR POLYSTYRENE (S4900/50# SCK) as manufactured by Avery Dennison. Substrate 14 may be cut from a roll of material in any desired shape or size appropriate for adhering test strip 12 to a microscope slide after a test sample is captured on test strip 12. In particular embodiments, substrate 14 may be smaller than a standard microscope slide. Thus, where a microscope slide has a length on the order of 3.5″ and a width on the order of 1″, substrate 14 may have a length on the order of 3.5″ and a width on the order of 0.5″. Alternatively, substrate 14 may have dimensions that are substantially the same as a standard microscope slide. Accordingly, where a microscope slide is on the order of 3.5″ by 1″, substrate 14 may also be on the order of 3.5″ by 1″. The recited dimensions, however, are merely exemplary. The present invention contemplates that substrate 14 may have any dimensions suitable for supporting a test sample.

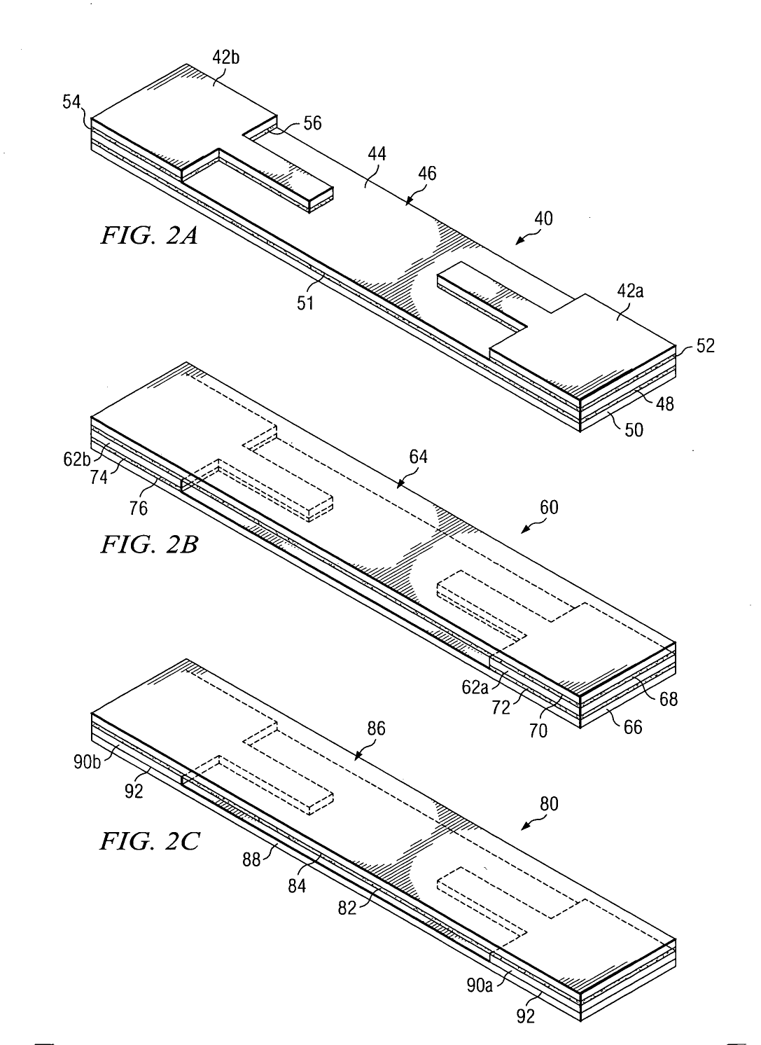

Test strip 12 also includes an adhesive layer (not shown) applied to the side of substrate 14 that is adjacent to backing 16. The adhesive layer removably adheres at least a portion of test strip 12 to backing 16. Thus, each test strip 12 may be selectively removed from backing 16 for the collection of a test sample. Once removed from backing 16, the adhesive layer operates to capture the test sample on the surface of test strip 12. The captured test sample may then be identified by lab technicians to determine the particular type of mycological sample on test strip 12. Example adhesive products that may comprise the adhesive layer adhering test strip 12 to backing 16 are discussed in greater detail with regard to FIGS. 2A-2C.

As discussed above, each test strip 12 includes at least one handling surface 18. Handling surface 18 may include a cardstock or other paper that adds rigidity to test strip 12. Additionally, the material used in handling surface 18 may be opaque such that when test strip 12 is viewed through a microscopic device light may not pass through handling surface 18. As one example, handling surface 18 may be comprised of 8 Point White C IS SBS as manufactured by Green Bay Packaging, Inc. In particular embodiments, each test strip 12 includes two handling surfaces 18a and 18b, which are positioned opposite one another on the ends of test strip 12. Where test strip 12 includes two handling surfaces 18a and 18b, handling surfaces 18a and 18b may also operate to define a contact area 20 on test strip 12. Contact area 20 provides defined boundaries on test strip 12 for a mold, fungal, or other sample to be trapped for the identifying process.

The dimensions of handling surfaces 18a and 18b may be varied and may depend on the size of substrate 14 and the desired size of contact area 20. In particular embodiments, handling surfaces 18a and 18b may be the same width as substrate 14. For example, where substrate 14 has a width on the order of 0.5″, handling surfaces 18a and 18b may also have a width on the order of 0.5″. As another example, where the width of substrate 14 is the same as a standard microscope slide, the width of handling surfaces 18a and 18b may be on the order of 1″. In alternate embodiments, handling surfaces 18a and 18b may be narrower or wider than substrate 14 as is desired by the particular user. The length of each handling surface 18a and 18b may also be varied depending on the length of substrate 14 and the desired size of contact area 20. For example, where substrate 14 is 0.5″ by 2.5″, handling surfaces 18a and 18b may have a length on the order of 0.5″. Accordingly, test strip 12 may have a contact area 20 on the order of 0.5″ by 1.5″. Alternatively, handling surfaces 18a and 18b may have a length on the order of 1.0″, and contact area 20 may have dimensions on the order of 0.5″ by 0.5″. The recited dimensions, however, are merely exemplary. The present invention contemplates that substrate 14 and handling surfaces 18 may have any appropriate dimensions for defining contact area 20 of a sufficient size to capture the test sample.

Handling surfaces 18 are positioned such that a user removing test strip 12 from sheet 10 may grasp the test strip 12 by the one or more handling surfaces 18. Where test strip 12 includes two handling surfaces 18a and 18b, the user may pinch handling surfaces 18a and 18b against one another between the user's thumb and index finger. The user may hold test strip 12 in this manner while a sample is obtained. Because the user's fingers touch handling surfaces 18a and 18b and not the other portions of test strip 12, contamination from the user's fingers is limited to handling surfaces 18a and 18b. The other portions of test strip 12 remain free of contamination. Where handling surfaces 18a and 18b are opaque, a lab technician identifying a test sample on test strip 12 may not see contamination present on handling surfaces 18a and 18b. Thus, the contamination resulting from a user's fingers need not be identified by the lab technician.

In particular embodiments, the cardstock or other material comprising handling surface 18 may be colored. For example, test strips 12 on sheet 10 may include black handling surfaces 18. Alternatively, test strips 12 on sheet 10 may include handling surfaces 18 that are of a lighter color such that the test strips 12 may be labeled. Test strips 12 may be pre-labeled. For example, test strips 12 may be pre-labeled with bar codes. Each test strip 12 may have a particular bar code associated with test strip 12. The bar codes may be used to identify where the test sample was obtained, by whom the test sample was obtained, or any other information associated with test strip 12. In particular embodiments, a particular barcode may identify the particular location at the test site from where the test sample was obtained. For example, the barcode for a test strip 12 may indicate that the test sample was obtained in the kitchen, living room, or another room of the house or building.

In other embodiments, test strips 12 may be labeled with pre-printed numbers or words. For example, numbers may be printed on test strips 12 such that each test strip may be distinguished from another test strip 12. The field technician and lab technician working with test strips 12 may associate a specific number with a particular location at the test site. For example, test strips 12 on sheet 10 may be labeled 1-20. The field technician and lab technician may associate a particular test strip 12 with a label of “1” with the kitchen and a particular test strip 12 with a label of “5” with the living room. Such associations may be universally understood by both the field technician and the lab technician. Alternatively, the field technician may keep records associating the pre-printed labels with the location from where each test sample was obtained. Thus, the field technician may create a key that is associated with test strips 12 from sheet 10. The key may then accompany test strips 12 to the lab so that the key may be used by the lab technician during the identification process. Alternatively, test strips 12 may be pre-printed with words on handling surfaces 18. For example, a particular test strip 12 may be pre-printed with the word “living room” or an abbreviation therefore. Other test strips 12 on sheet 10 may be pre-printed with other words describing other rooms or locations in the house or building being tested.

In other embodiments, first and second handling surfaces 18 may be configured such that the field technician can label each test strip 12 as the test samples are obtained. For example, the field technician may label each test strip 12 using a wax pencil or other writing utensil suitable for writing on handling surfaces 18. Hand labeling allows the field technician to indicate on test strip 12 where the test sample was obtained as the test sample is obtained. For example, the field technician obtaining the test sample may label a test strip 12 by indicating the room or other area in the house or building being tested from where the test sample was obtained. Where the field technician uses a particular test strip 12 to obtain a test sample from the living room, the field technician may write “living room” or an abbreviation thereof on test strip 12. Alternatively, the field technician may assign the living room a number and label the particular test strip 12 with the assigned number. In some embodiments, the field technician may keep a key associating the assigned numbers for test strip 12 with the location from where the test samples were obtained.

In other embodiments, handling surfaces 18 for each test strip 12 on sheet 10 may be colored differently such that color-coding may be used to identify where each test sample was obtained. Thus, each color may be associated with a different area of the house or building from where the test samples are taken. For example a user of test strips 12 may associate a test strip with a red handling surface 18 with the living room and a test strip with a blue handling surface 18 with the kitchen. In still other embodiments, each test strip 12 on sheet 10 may be pre-numbered to identify each test strip 12. The numbers may be printed on the surface of handling surfaces 18. Accordingly, handling surfaces 18 may be manufactured in a variety of ways to distinguish test strips 12 from one another.

In particular embodiments, handling surfaces 18 may include extending areas 22. Extending areas 22 may be integrally formed with handling surfaces 18 and may be of the same material comprising handling surfaces 18. Alternatively, extending areas 22 may be formed separately from handling surfaces 18. Where extending areas 22 are formed separately, extending areas 22 may be of the same material comprising handling surfaces 18 or may be of any other material suitable for adding rigidity to test strip 12. In operation, extending areas 22 may further define the portion of test strip 12 comprising contact area 20. Additionally, extending areas 22 may act as spacers between handling surfaces 18 contact area 20. Thus, extending areas 22 may further separate contact area 20 from the portion of test strip 12 that contacts the field technician's fingers.

The dimensions of extending areas 22 may be varied depending on the width and length of test strip 12, the desired size of contact area 20, and the amount of space desired to separate handling surfaces 18 and contact area 20. In particular embodiments, extending areas 22 may have a width on the order of 0.125″ and a length on the order of 0.5″. Accordingly, contact area 20 may have dimensions on the order of 0.5″ by 0.5″. The recited dimensions, however, are merely exemplary. The present invention contemplates that extending areas 22 may have any appropriate dimensions suitable for defining contact area 20. As described above, extending areas 22 may add rigidity to test strip 12 such that when used to obtain a test sample only contact area 20 may be pressed on to the test site. Accordingly, extending areas 22 may operate as stops that prevent portions of test strip 12 other than contact area 20 from making contact with the test site.

Backing 16 provides a surface to which multiple test strips 12 may be adhered to form sheet 10. The material comprising backing 16 is such that test strips 12 may be selectively removed from backing 16 without damaging or otherwise harming test strips 12. In particular embodiments, backing 16 may include a waxed paper or other slick surface from which test strips 12 may be removed. In operation, a user may separate test strip 12 from backing 16 prior to obtaining a test sample. As illustrated, a corner of test strip 12 may be released from backing 16 using the one or more handling surfaces 18. In particular embodiments, backing 16 may have a thickness on the order of 0.002″. The present invention contemplates, however, that backing 16 may be of any appropriate thickness suitable for supporting test strips 12. Additionally, although backing 16 is illustrated as supporting multiple test strips 12, each individual test strip 12 could be adhered to a separate backing 16. Accordingly, test strips 12 may be packaged individually or as a group.

The components of test strips 12 may be configured in a variety of ways without changing the functionality of test strips 12. FIGS. 2A-2C illustrate various example test strips in accordance with particular embodiments of the invention. Because the various layers and components comprising the example test strips may be very thin, the dimensions associated with the layers and components of the example test strips shown in FIGS. 2a-2c have been exaggerated for purposes of illustration. The example test strips illustrated in FIGS. 2a-2c are not shown to scale.

FIG. 2A illustrates an example test strip 40 that includes a first handling surface 42a and second handling surface 42b adhered to the outside surface, or first surface 44, of a substrate 46. In particular embodiments, substrate 14 may have a thickness on the order of 0.002″, and handling surfaces 42 may have a thickness on the order of 2.3-2.7 mils. The present invention contemplates, however, that substrate 14 and handling surfaces 42 may be of any appropriate thickness suitable for use in obtaining and supporting a test sample. Substrate 46 includes a first adhesive layer 48 that is formed on the inside surface, or second surface 51, of substrate 46 to adhere substrate 46 to backing 50. First adhesive layer 48 may also operate to capture a test sample after test strip 40 is removed from backing 50. First adhesive layer 48 may include any general purpose acrylic adhesive or epoxy suitable for adhering substrate 46 to backing 50 and capturing a test sample after test strip 40 is removed from backing 50. First adhesive layer 48 may be substantially clear when applied to substrate 46 such that a captured test sample may be easily seen on test strip 40 when viewed through microscopic magnification. Alternatively, first adhesive layer 48 may not be clear but still be transparent enough that the captured test sample may be viewed through microscopic magnification. Where adhesive layer 48 is not crystal clear, first adhesive layer 48 may give lab technicians a focal length reference when viewing a test sample through a microscopic device. In particular embodiments, first adhesive layer 48 may be similar to that used in typical scotch tape.

The particular material comprising first adhesive layer 48 may be at least partially determined by the particular material used as substrate 46. For example, where substrate 46 is of polypropylene, first adhesive layer 48 may include ADHESIVE 504 as manufactured by Green Bay Packaging, Inc. First adhesive layer 48 may be applied directly to second surface 51 under temperature conditions appropriate for the particular adhesive material being used. For example, where first adhesive layer 48 is comprised of ADHESIVE 504, first adhesive layer 48 may be applied at a temperature of 35° F. In particular embodiments, first adhesive layer 48 may have a thickness on the order of 0.00001″. The present invention contemplates, however, that first adhesive layer 48 may be of any appropriate thickness suitable for adhering substrate 46 to backing 50 and for capturing a test sample after test strip 40 is removed from backing 50.

A second adhesive layer 52 and a third adhesive layer 54 operate to adhere first handling surface 42a and second handling surface 42b, respectively, to first surface 44 of substrate 46. Second and third adhesive layers 52 and 54 may include any general-purpose acrylic adhesive or epoxy suitable for adhering first and second handling surfaces 42a and 42b to substrate 46. The particular material comprising second and third adhesive layers 52 and 54, however, may be at least partially determined by the particular materials comprising substrate 46 and first and second handling surfaces 42a and 42b. In particular embodiments, the material forming second and third adhesive layers 52 and 54 may be the same as the material forming first adhesive layer 48. Accordingly, where first adhesive layer 48 is ADHESIVE 504 as manufactured by Green Bay Packaging, Inc., second and third adhesive. layers 52 and 54 may also include ADHESIVE 504. In particular embodiments, second and third adhesive layers 52 and 54 may have a thickness on the order of 0.00001″. The present invention contemplates, however, that second and third adhesive layers 52 and 54 may be of any appropriate thickness suitable for adhering first and second handling surfaces 42 to substrate 46.

Second and third adhesive layers 52 and 54 may be applied to handling surfaces 42a and 42b or to substrate 46. For example, in particular embodiments, second and third adhesive layers 52 and 54 may be applied directly to first surface 44 of substrate 46. In other embodiments, second and third adhesive layers 52 and 54 may be applied directly to first side 56 of handling surfaces 42a and 42b. Regardless, second and third adhesive layers 52 and 54 may be applied under appropriate temperature conditions for the particular materials comprising second and third adhesive layers 52 and 54. For example, where second and third adhesive layers 52 and 54 are comprised of ADHESIVE 504, second and third adhesive layers 52 and 54 may be applied at a temperature of 35° F.

As described above, test strip 40 may be manufactured in layers. Thus, test strip 40 may be produced by forming one layer on top of another. However, the particular order in which the layers are formed may be varied. For example, the manufacturing of test strip 40 may begin with cutting appropriately sized pieces of substrate 46 from a sheet of polystyrene. First adhesive layer 48 may be applied to second surface 51 of substrate 46 and the resulting adhesive substrate 46 may be adhered to backing 50. First and second handling surfaces 42 may then be positioned on first surface 44 of substrate 46. In alternative methods of manufacturing test strips 40, first and second handling surfaces 42 may be positioned on first surface 44 before substrate 46 is adhered to backing 50. As such, first adhesive layer 48 may be formed on second surface 51 before or after first and second handling surfaces 42 are positioned on first surface 44. In particular embodiments, however, it may be desirable to limit the number of steps performed between the step of applying first adhesive layer 48 to second surface 51 of substrate 46 and the step of adhering the resulting adhesive substrate 46 to backing 50. This may be desirable to limit the amount of contamination captured in first adhesive layer 48 during the manufacturing process.

FIG. 2B illustrates an example test strip 60 that includes a first handling surface 62a and a second handling surface 62b forming an intermediary layer between substrate 64 and backing 66. Substrate 64 includes a first adhesive layer 68 that is formed on the inside surface, or second surface 70, of substrate 64 to adhere at least a portion of substrate 64 to backing 66. First adhesive layer 68 may also operate to adhere substrate 64 to first and second handling surfaces 62a and 62b. First adhesive layer 68 may include any general purpose acrylic adhesive or epoxy suitable for adhering substrate 64 to backing 66 and first and second handling surfaces 62a and 62b and may be similar to adhesive layer 48 described above with regard to FIG. 2A. Accordingly, in particular embodiments, first adhesive layer 68 may include ADHESIVE 504 as manufactured by Green Bay Packaging, Inc.

As illustrated, test strip 60 includes a second adhesive layer 72 and a third adhesive layer 74 applied directly to handling surfaces 62a and 62b. Second adhesive layer 72 and third adhesive layer 74 operate to adhere first handling surfaces 62a and second handling surface 62b, respectively, to backing 66. Second and third adhesive layers 72 and 74 may include any general-purpose acrylic adhesive or epoxy suitable for adhering first and second handling surfaces 62a and 62b to backing 66. Accordingly, second and third handling surfaces 62 and 62b may be similar to first, second, and third adhesive layers 48, 52, and 54 described above with regard to FIG. 2A. For example, where substrate 64 is of polypropylene and first and second handling surfaces 62a and 62b are of cardstock, second and third adhesive layers 72 and 74 may include ADHESIVE 504 as manufactured by Green Bay Packaging, Inc.

Similar to test strip 40, test strip 60 may be manufactured in layers. Thus, test strip 60 may be built by forming one layer on top of another. Again, the particular order in which the layers are formed may be varied. For example, the manufacturing of test strip 60 may begin by cutting appropriately sized pieces of substrate 64 from a sheet of polystyrene or other appropriate material. First adhesive layer 68 may be applied to second surface 70 of substrate 64. First and second handling surfaces 62 may then be cut from a sheet of cardstock or other appropriate material. Second and third adhesive layers 72 and 74 may be applied directly on first sides 76 of first and second handling surfaces 72, and first and second handling surfaces 62 may be positioned proximate to substrate 64 such that first and second handling surfaces 62 may be on opposite ends of substrate 64. The resulting adhesive substrate 64 may be adhered to backing 66 resulting in test strip 60. In an alternative method of manufacturing, second and third adhesive layers 72 and 74 may be applied to first sides 76 of first and second handling surfaces 62 before first and second handling surfaces 62 are adhered to substrate 64. In particular embodiments, however, it may be desirable to limit the amount of contamination captured in first adhesive layer 68 during the manufacturing process. Accordingly, the number of steps performed between the step of applying first adhesive layer 68 to second surface 70 of substrate 64 and the step of adhering the resulting adhesive substrate 64 to backing 66 may be limited.

FIG. 2C illustrates an example test strip 80 that includes only one adhesive layer. First adhesive layer 82 is formed on the inside surface, or second surface 84, of substrate 86. Similar to first adhesive layer 68 described above with regard to FIG. 2B, first adhesive layer 82 adheres at least a portion of substrate 86 to a backing 88. First adhesive layer 82 also adheres substrate 86 to first and second handling surfaces 90a and 90b. Accordingly, test strip 80 may be generally formed as described above with regard to test strip 60 of FIG. 2B. In the illustrated embodiment, however, test strip 80 does not include additional adhesive layers on first surfaces 92 of first and second handling surfaces 90a and 90b. Thus, test strip 80 does not include adhesive adhering first and second handling surfaces 90a and 90b to backing 88, and first and second handling surfaces 90a and 90b remain unattached from backing 88. Unattached first and second handling surfaces 90a and 90b allows a user to more easily separate test strip 80 from backing 88. Additionally, unattached first and second handling surfaces 90a and 90b may reduce contamination on test strip 80. For example, when a user holds test strip 80 using first and second handling surfaces 90a and 90b, contamination from the user's fingers is not captured on test strip 80 since test strip 80 does not include adhesive on first surfaces 92, which contact the user's fingers.

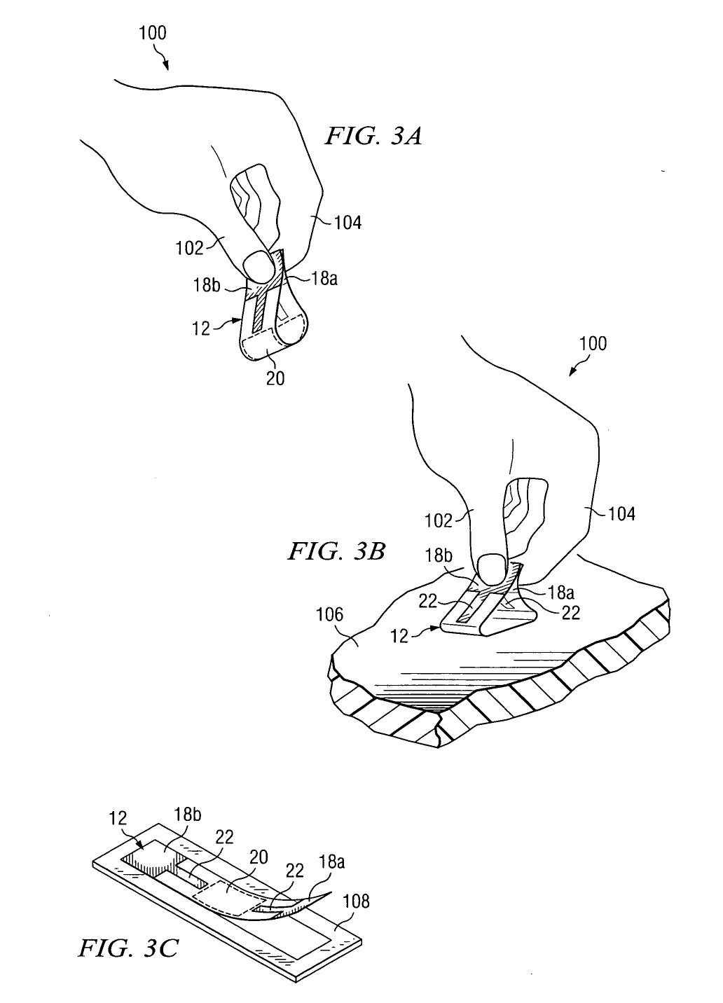

FIGS. 3A-3C illustrate an example method of using test strip 12 in accordance with an embodiment of the invention. As described above with regard to FIG. 1, a user may remove test strip 12 from backing 16 by grasping test strip 12 by the one or more handling surfaces 18 and peeling test strip 12 away from backing 16. Test strip 12 may then be held by a user 100 in the manner illustrated in FIG. 3A. Specifically, user 100 may pinch handling surfaces 18a and 18b such that handling surfaces 18a and 18b are lying adjacent to one another between the user's thumb 102 and index finger 104. The user may hold test strip 12 in this manner while a sample is obtained. Because the fingers of user 100 only touch handling surfaces 18, contamination resulting from the fingers of user 100 is limited to handling surfaces 18a and 18b. Accordingly contact area 20 may be free of contamination prior to the test sample being obtained.

FIG. 3B illustrates test strip 12 as the test sample is obtained from a test site 106. Holding test strip 12 in the manner described above, user 100 presses contact area 20 of test strip 12 against test site 106. First adhesive layer (not shown) on the surface of test strip 12 that is pressed against test site 106 operates to capture a test sample from test site 106. In particular embodiments, little force may be required to capture the test sample. Accordingly, only a light touch of contact area 20 against test site 106 may be necessary to transfer the test sample from test site 106 to contact area 20. As illustrated, test strip 12 includes extending areas 22. As described above with regard to FIG. 1, extending areas 22 may provide test strip 12 with additional rigidity. Thus, extending areas 22 may prevent portions other than contact area 20 from making contact with test site 106. For example, a user 100 may begin pressing test strip 12 against test site 106. As the ends of extending areas 22 make contact with test site 106 and are substantially perpendicular to test site 106, extending areas 22 may provide a resistance preventing further portions of test strip 12 from making contact with test site 106. Accordingly, the test sample obtained may be confined to contact area 20.

FIG. 3C illustrates test strip 12 as it is being applied to a microscope slide 108 for the identification process. Test strip 12 may be adhered to microscope slide 108 such that the test sample captured in contact area 20 may be identified. As described above with regard to FIG. 1, adhesive substrate 14 comprising contact area 20 may be substantially transparent to allow light from a microscopic device to pass through adhesive substrate 14. Accordingly, a lab technician may view test strip 12 under microscopic magnification and identify the particular type of mycological sample contained thereon. Adhesive substrate 14 may appear substantially transparent to the lab technician when viewed through the microscopic device. Where adhesive substrate 14 is not completely clear but is substantially clear, substrate 14 may provide a frame of reference that the lab technician may use in identifying the test sample. Because handling surfaces 18 and extending areas 22 are opaque, light from the microscopic device may not pass through handling surfaces 18 and extending areas 22. Accordingly, a lab technician identifying a test sample on test strip 12 may not see contamination present on handling surfaces 18a and 18b and the lab technician's attention may be focused on contact area 20. Thus, the contamination resulting from the user's fingers need not be identified by the lab technician. Additionally, because contact area 20 is clearly defined for the lab technician, contact area 20 provides a border beyond which the lab technician need not look.

To identify the test sample, the lab technician may first divide contact area 20 into a grid of similarly sized boxes. For example, the lab technician may transpose a grid of similarly sized boxes on contact area 20. In particular embodiments, each box in the grid may have dimensions on the order of 0.25″ by 0.25″. Where, for example, contact area 20 has dimensions on the order of 0.5″ by 0.5″, the grid on contact area 20 may include 4 boxes. The lab technician may then focus on a particular number of boxes of the grid to identify the test sample captured in the particular boxes. For example, where contact area 20 includes a grid of 4 boxes, a lab technician may merely be required to inspect 1 box. Because lab technicians may identify test samples in this manner, it may be desirable, in particular embodiments, to include a grid of similarly sized boxes pre-printed on adhesive substrate 14. More specifically, the grid of boxes may be pre-printed on substrate 14 over the desired contact area 20. Where test strips 12 include a pre-printed grid, the lab technician identifying the particular test sample is not required to invest time transposing a grid on test strip 12 and can instead focus on identifying the test sample.

FIG. 4 illustrates an example tool 120 for obtaining test samples in accordance with an embodiment of the invention. Tool 120 may be used to obtain test samples from hard to reach test sites 106. For example, tool 120 may be used to hold test strip 12 while a test sample is taken from a ceiling or from a hard to reach crack or crevice. Tool 120 includes a handle 124 that is coupled to a telescoping arm 126. Handle 124 may be grasped in a field technician's hand while telescoping arm 126 is extended or retracted as needed to reach a particular test sample. A clip 128 is coupled to the end of telescoping arm 126 and is opposite to handle 124. Clip 128 is spring loaded such that clip 128 may be used to hold first and second handling surfaces 18a and 18b of test strip 12 adjacent to one another while a test sample is obtained. Accordingly, clip 128 may hold test strip 12 in a manner similar to that described above with regard to FIG. 3A. In various embodiments, clip 128 may include a binder clip, alligator clip, paper clip, or other suitable type of clip for clamping first and second handling surfaces 18a and 18b against one another.

In operation, a field technician may remove test strip 12 from backing 16 by grasping test strip 12 by the one or more handling surfaces 18 and peeling test strip 12 away from backing 16. The field technician may then secure test strip 12 between in clip 128 by clipping first and second handling surfaces 18a and 18b adjacent to one another. In the clipped position, the adhesive layer (not shown) formed on the surface of test strip 12 is exposed. Telescoping arm 126 may then be extended or retracted as needed to reach test site 106. By hanging on to handle 124, the field technician may position test strip 12 proximate to the particular test site 106. The field technician may then use tool 120 to press test strip 12 against test site 106 to capture the test sample in the adhesive layer on test strip 12. Telescoping arm 126 may then be retracted, and the field technician may remove test strip 12 from clip 128. Test strip 12 may then be placed on a microscope slide as was described with regard to FIG. 3C for identification of the test sample.

Although embodiments of the invention and their advantages are described in detail, a person skilled in the art could make various alterations, additions, and omissions without departing from the spirit and scope of the present invention, as defined by the appended claims.

1. A test strip for obtaining a test sample, comprising:
an adhesive substrate comprising a first surface and a second surface, the second surface comprising a first adhesive layer adhering at least a portion of the adhesive substrate to a backing;
a first handling surface positioned proximate to a first end of the substrate; and
a second handling surface positioned proximate to a second end of the substrate, the first and second handling surfaces defining a contact area for collecting a test sample.

2. The test strip of claim 1, further comprising
a second adhesive layer proximate to the first handling surface, the second adhesive layer adhering the first handling surface to the first surface of the substrate; and
a third adhesive layer proximate to the second handling surface, the third adhesive layer adhering the second handling surface to the first surface of the substrate.

3. The test strip of claim 1, further comprising
a second adhesive layer proximate to the first handling surface, the second adhesive layer adhering a first side of the first handling surface to the backing; and
a third adhesive layer proximate to the second handling surface, the third adhesive layer adhering the second handling surface to the backing.

4. The test strip of claim 1, wherein the first adhesive layer adheres at least a portion of the second surface of the substrate to the first and second handling surfaces.

5. The test strip of claim 1, wherein the first adhesive layer adheres substantially all of the substrate to the backing.

6. The test strip of claim 1, wherein the first and second handling surfaces remains unattached from the backing.

7. The test strip of claim 1, wherein the contact area is configured to be pressed against a test site to collect the test sample.

8. The test strip of claim 7, wherein the first and second ends of the substrate are configured to be held adjacent to each other between two fingers of a user as the contact area is pressed against the test site.

9. The test strip of claim 7, wherein the first and second ends of the substrate are configured to be held adjacent to each other by a tool as the contact area is pressed against the test site.

10. The test strip of claim 7, wherein the first handling surface comprises a first extending area and the second handling surface comprises a second extending area, the first and second extending areas providing resistance such that only the contact area is pressed against the test site.

11. The test strip of claim 1, wherein the backing comprises a waxed surface configured to be separated from the substrate such that the first adhesive layer remains proximate to the substrate after the substrate and the backing are separated, the first adhesive layer operable to capture the test sample.

12. The test strip of claim 1, wherein the first and second handling surfaces comprise an opaque material.

13. The test strip of claim 1, wherein the first and second handling surfaces comprise a colored cardstock paper.

14. The test strip of claim 1, wherein the first and second handling surfaces comprise a pre-printed label.

15. The test strip of claim 1, wherein the first and second handling surfaces are operable to receive a handwritten label.

16. The test strip of claim 1, wherein the substrate includes a pre-printed grid transposed over the contact area.

17. A method for obtaining a test sample, comprising:
removing a test strip from a backing, the test strip comprising:
an adhesive substrate comprising a first surface and a second surface, the second surface comprising a first adhesive layer adhering at least a portion of the adhesive substrate to the backing;
a first handling surface positioned proximate to a first end of the substrate; and
a second handling surface positioned proximate to a second end of the substrate, the first and second handling surfaces defining a contact area for collecting a test sample;
pressing the contact area against a test site to obtain the test sample, the first and second handling surfaces held adjacent to each other to avoid contamination on the test strip outside the contact area.

18. The method of claim 17, wherein the test strip further comprises:
a second adhesive layer proximate to the first handling surface, the second adhesive layer adhering the first handling surface to the first surface of the substrate; and
a third adhesive layer proximate to the second handling surface, the third adhesive layer adhering the second handling surface to the first surface of the substrate.

19. The method of claim 17, wherein the test strip further comprises:
a second adhesive layer proximate to the first handling surface, the second adhesive layer adhering a first side of the first handling surface to the backing; and
a third adhesive layer proximate to the second handling surface, the third adhesive layer adhering the second handling surface to the backing.

20. The method of claim 17, wherein the first adhesive layer adheres at least a portion of the second surface of the substrate to the first and second handling surfaces.

21. The method of claim 17, wherein the first adhesive layer adheres substantially all of the substrate to the backing.

22. The method of claim 17, wherein the first and second handling surfaces remain unattached from the backing.

23. The method of claim 17, further comprising holding the first and second ends of the substrate adjacent to each other as the contact area is pressed against the test site.

24. The method of claim 17, further comprising holding the first and second handling surfaces adjacent to each other to obtain the test sample.

25. The method of claim 17, further comprising:
positioning the first and second ends of the substrate adjacent to each other in a clip of a tool; and
using the tool to press the contact area against the test site.

26. The method of claim 17, wherein the first handling surface comprises a first extending area and the second handling surface comprises a second extending area, the first and second extending areas providing resistance such that only the contact area is pressed against the test site.

27. The method of claim 17, wherein the backing comprises a waxed surface configured to be separated from the substrate such that the first adhesive layer remains proximate to the substrate after the substrate and the backing are separated, the first adhesive layer operable to capture the test sample.

28. The method of claim 17, wherein the first and second handling surfaces comprise an opaque material.

29. The method of claim 17, wherein the first and second handling surfaces comprise a colored cardstock paper.

30. The method of claim 17, wherein the first and second handling surfaces comprise a pre-printed label.

31. The method of claim 17, wherein the first and second handling surfaces are operable to receive a handwritten label.

32. The method of claim 17, wherein the substrate includes a pre-printed grid transposed over the contact area.

33. The method of claim 17, further comprising positioning the test strip on a microscopic slide for identification of the test sample.

34. A method for manufacturing a test strip, comprising:
positioning a first handling surface proximate to a first end of an adhesive substrate, the adhesive substrate comprising a first surface and a second surface, the second surface comprising a first adhesive layer;
positioning a second handling surface proximate to a second end of the substrate, the first and second handling surfaces defining a contact area for collecting a test sample; and
adhering at least a portion of the adhesive substrate to a backing.

35. The method of claim 34, further comprising:
applying a second adhesive layer to the first handling surface, the second adhesive layer operable to adhere the first handling surface to the first surface of the substrate; and
applying a third adhesive layer to the second handling surface, the third adhesive layer operable to adhere the second handling surface to the first surface of the substrate.

36. The method of claim 34, further comprising:
applying a second adhesive layer to the first handling surface, the second adhesive layer operable to adhere a first side of the first handling surface to the backing; and
applying a third adhesive layer to the second handling surface, the third adhesive layer operable to adhere a first side of the second handling surface to the backing.

37. The method of claim 34, wherein the first adhesive layer adheres at least a portion of the second surface of the substrate to the first and second handling surfaces.

38. The method of claim 34, wherein the first adhesive layer adheres substantially all of the substrate to the backing.

39. The method of claim 34, wherein the first and second handling surfaces remain unattached from the backing.

40. The method of claim 34, where the contact area is configured to be pressed against a test site to collect the test sample.

41. The method of claim 40, wherein the first and second ends of the substrate are configured to be held adjacent to each other as the contact area is pressed against the test site.

42. The method of claim 34, wherein the first handling surface comprises a first extending area and the second handling surface comprises a second extending area, the first and second extending areas providing resistance such that only the contact area may be pressed against the test site.

43. The method of claim 34, wherein the backing comprises a waxed surface configured to be separated from the substrate such that the first adhesive layer remains proximate to the substrate after the substrate and the backing are separated, the first adhesive layer operable to capture the test sample.

44. The method of claim 34, wherein the first and second handling surfaces comprise an opaque material.

45. The method of claim 34, wherein the first and second handling surfaces comprise a colored cardstock paper.

46. The method of claim 34, further comprising printing a label on the first and second handling surfaces.

47. The method of claim 34, wherein the first and second handling surfaces are operable to receive a handwritten label.

48. The method of claim 34, further comprising printing a grid on the substrate, the grid transposed over the contact area.
